(19) United States
(12) Patent Application Publication
(10) Pub. No.: US 2007/0036928 A1
(43) Pub. Date: Feb. 15, 2007

(54) Temporary camouflage tattoo

(76) Inventors: James K. Givens, El Cajon, CA (US); Mark H. Dice, El Cajon, CA (US)

Correspondence Address: DAVID B. WALLER & ASSOCIATES, 5677 OBERLIN DRIVE, SUITE 214, SAN DIEGO, CA, 92121, US

(21) Appl. No.: 11/123,636

(22) Filed: May 6, 2005

(51) Int. Cl. B32B 33/00

(52) U.S. Cl. 428/40.1; 428/350

(57) ABSTRACT

The present invention is moisture activated removable facial camouflage tattoo carrier sheet for disguising a human face. The tattoo carrier sheet comprises a water permeable transfer sheet, at least one temporary and removable moisture activated facial camouflage tattoo lo disposed on the water permeable transfer sheet. A protective release sheet is removably disposed on the water permeable transfer sheet over the facial camouflage tattoo as temporary protective covering for the facial camouflage tattoo.

### FIELD OF INVENTION

This invention relates to a removable or soluble tattoo for transferring a camouflage pattern onto a person's face or exposed areas. In a particularly preferred application, tattoos are provided for use in camouflaging military personnel.

### BACKGROUND OF THE INVENTION

For years people have applied masks, paints and more recently cosmetic formulations to their faces to mask or disguise their appearance. This has been done in traditional dances or ceremonies, in the theater or on stage, in the military or for hunting and on holidays such as Halloween. While masks may be worn for a number of occasions such as parties, trick or treating and on stage they are generally not recommended for use in military operations or hunting. For a number of reasons masks, with the exception of ski masks, are not used for these activities often times because they are uncomfortable, can obstruct viewing and can be easily displaced during use. Face paints such as those currently used by military personnel are generally oil based to prevent being compromised by submerging in water or by rain. Because of this these paints are cumbersome to apply and difficult to remove. Cosmetic formulations and make-up are removable with soap and water but are time consuming to apply.

Consequently, there is a need for a composition that can be applied to a users face to disguise or camouflage their appearance that is able to withstand submersion in water and rain, that can be easily removed with soap and water and is easy to apply.

### SUMMARY OF THE INVENTION

In accordance with the present invention a moisture activated removable facial camouflage tattoo carrier sheet is provided for disguising a human face. In one preferred aspect of the present invention the moisture activated removable facial camouflage tattoo carrier sheet comprises a water permeable transfer sheet, at least one temporary and removable moisture activated facial camouflage tattoo disposed on the water permeable transfer sheet, and a protective release sheet removably disposed on the water permeable transfer sheet over the facial camouflage tattoo as a temporary covering and to protect the facial camouflage tattoo.

In one embodiment of the present invention the moisture activated removable facial camouflage tattoo carrier sheet comprises water-soluble hypoallergenic vegetable dye. The dye may be provided in a variety of patterns including a woodland pattern, a desert pattern, a tiger stripe pattern, and an urban pattern. These patterns may be digitally created or maybe created by hand. When the pattern is a desert pattern it may be for example a chocolate-chip desert pattern and a tri-color desert pattern. The carrier sheet may be provided in preformed shapes or in one continuous sheet that the user may cut into desired shapes. If the shapes are preformed they may be in shapes for application to the users face such as for the forehead, cheeks, chin, forehead and cheeks, cheeks and chin or forehead, cheeks and chin.

In another embodiment the moisture activated removable facial camouflage tattoo carrier sheet is transferable to and temporarily adheres to the skin of a human face upon application of water to the water permeable transfer sheet.

### BRIEF DESCRIPTION OF THE DRAWINGS

FIG. 1 is a diagrammatic representation of (A) a digital woodland pattern, (B) a digital desert pattern, (C) a general woodland pattern, (D) a “chocolate-chip” desert pattern, (E) a tri-color desert pattern, (F) a urban pattern and (G) a tiger stripe.

FIG. 2 is a diagrammatic representation of tattoo section pieces for application of potions of a tattoo to particular areas of the face.

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “moisture activated” as used herein refers to a removable facial camouflage tattoo that is readily transferable from a moisture permeable transfer sheet that carries the tattoo onto the human face. This is generally performed by the application of moisture or water as delivered by a sponge, cloth or the like, to the side of the moisture permeable sheet opposite the side the tattoo is located.

The term “removable” and “temporary” as used herein refers to the ability of the tattoo image to be wiped-off or removed from the skin on which it has been applied. Preferably this is performed by normal washing with conventional soaps, make-up or cosmetic removal compositions and the like. The removable tattoos of the present invention may be contrasted with permanent tattoos which cannot be wiped-off or removed by the compositions listed and can only be removed by surgically.

The term “ink” as used herein refers to a compound that is able to provide a desired color to the skin. Preferably ink includes dyes, colorants, pigments and the like. Preferably the ink is derived from a vegetable dye.

The term “majority” as used herein refers to greater than 50% of the entirety, greater than 60% of the entirety, greater than 70% of the entirety, greater than 80% of the entirety and/or greater than 90% of the entirety of an object such as a face.

The term “recreational” as used herein refers to activities conducted in the private sector as opposed to the military sector of our society. For example, the use of the tattoos of the present invention for recreational use could include deer hunting or paint ball games as opposed to military use which could include camouflaging the face of enlisted personnel for operations such as sniping enemy targets.

Removable Tattoo

The tattoos of the present invention may be provided on moisture activated transferable sheets that have the capability to transfer colorant materials directly to the skin or may be provided on flexible thin polymer slip layer, also known as a decal, that carries the image and has a contact adhesive on one side to allow the image to be affix directly to the skin. A wide variety of methods are known for the preparation of removable tattoos. One method for preparing removable eyebrow tattoos is disclosed in U.S. Pat. No. 6,161,554 and is incorporated herein in its entirety. Another method of manufacturing a temporary tattoo is by offset or silk screen conversion this method is described more fully in U.S. Pat. No. 5,958,560 and is incorporated herein in its entirety. This patent also describes methods that substantially reduced production time by utilizing advancements in laser jet printer technology. A method for preparing temporary tattoo decals is disclosed in U.S. Pat. No. 6,074,721 the contents of which are incorporate herein by reference in its entirety. The decals contemplated by the present invention when used for camouflaging purposes will have surfaces that reduce, or eliminate, the reflective qualities of the upper surface of the decal. More specifically, the flexible thin polymer slip will have a matte finish as opposed to a glossy finish so that light reflection is reduced to a minimum.

Common among all these methods is a water permeable transfer sheet. This sheet is preferably composed of a material that allows for moisture or water to pass from the backside of the sheet to the front side of the sheet in order to allow the tattoo and/or decal to be transferred and adhered to the skin. The water permeable transfer sheet is selected from materials that have a generally high rate of absorption. In one method described in the U.S. patents referenced the paper stock is 8 mil 100-lbs. stock. This heavy gauge paper adds stability when the coatings are applied. To the smooth side of the paper stock is applied a water-soluble coating in a layer approximately 0.1 mil or about 12 lbs. per ream to paper stock. They prefer a cellulose acetate base for this coating. The thickness of the coating allows the partial dissolution of the coating when exposed to water and allows it to separate from the paper stock and for the water soaked paper to be removed leaving the residue from the water soluble coating.

Adjacent to the water-soluble coating is a UV inhibitive layer that prevents UV energy from the sun or other sources from bleaching the ink of the tattoo. One composition that may be utilized is suntan lotion having a sun protection factor (SPF) of approximately 35. A thin and consistent layer of this coating is applied to the water-soluble coating. The coating is not water-soluble so it is not functionally affected by the water dissolution or partial dissolution of the water-soluble coating. Adjacent to the UV inhibitive layer coating is a non-water soluble coating referred to as an adhesive deadener. This adhesive deadener prevents the water and the water-soluble coating from penetrating the ink and dissolving the colors. It further binds the inks and the remainder of the coatings to the pressure sensitive adhesive so that it does not become tacky once applied to the skin. The base for this coating is polyvinyl alcohol and is applied in a thick and consistent coating of about 0.8 mils or 12 lbs. per ream of paper.

Adjacent to the adhesive deadener is clay based coating that aids in the ink drying and inks anchorage. The inks are then applied directly to this coating. The removable facial camouflage tattoo can comprise a ink, preferably consisting of a hypoallergenic water soluble vegetable dye or ink that is capable of being transferably moisture activated to adhere to the user's face upon application of moisture to the back of the water permeable transfer sheet.

Once the ink is deposited a pressure sensitive adhesive is applied over the image created with the ink. This adhesive is generally a hypoallergenic and water-resistant acrylic copolymer. Over this layer is applied a backing material generally a clear polymer film so that the tattoo may be viewed from the surface. Types of backing material include for example polypropylene, polyester or polyvinyl alcohol, Kraft or tag paper.

In use the backing sheet and second release coating are removed from the temporary tattoo exposing the adhesive. This surface is then applied to the desired skin area of the face. The paper is the exposed to water or moisture. Once saturated the paper may be removed leaving the temporary tattoo affixed to the skin.

Patterns

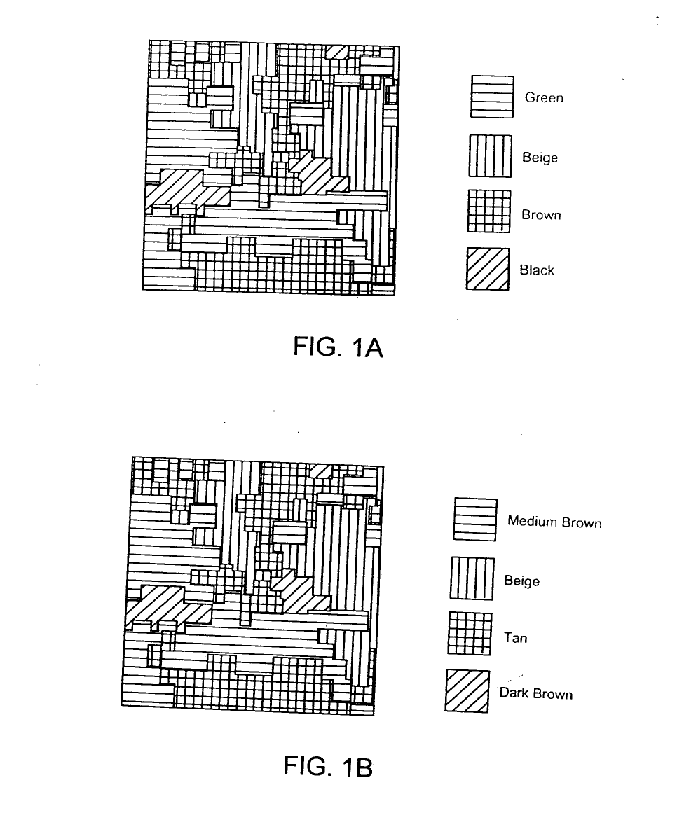

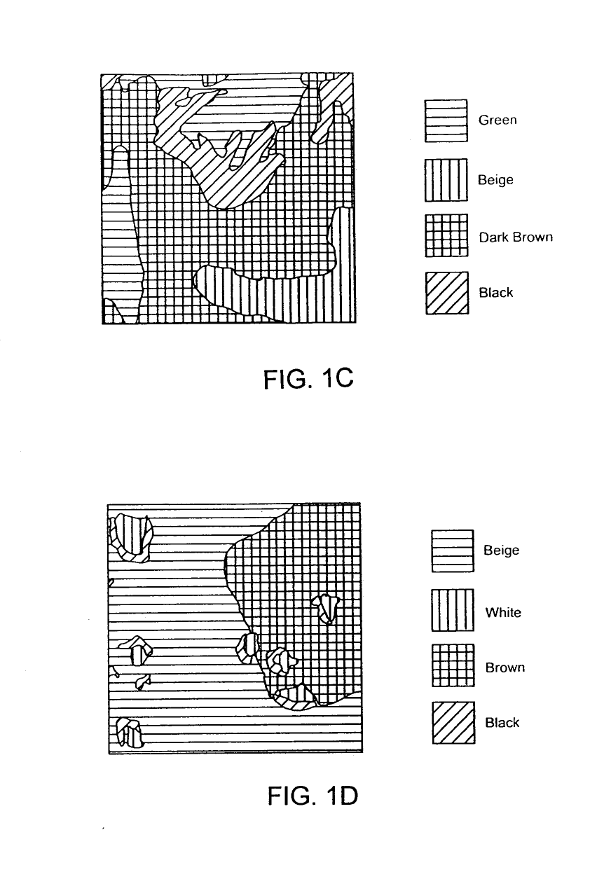

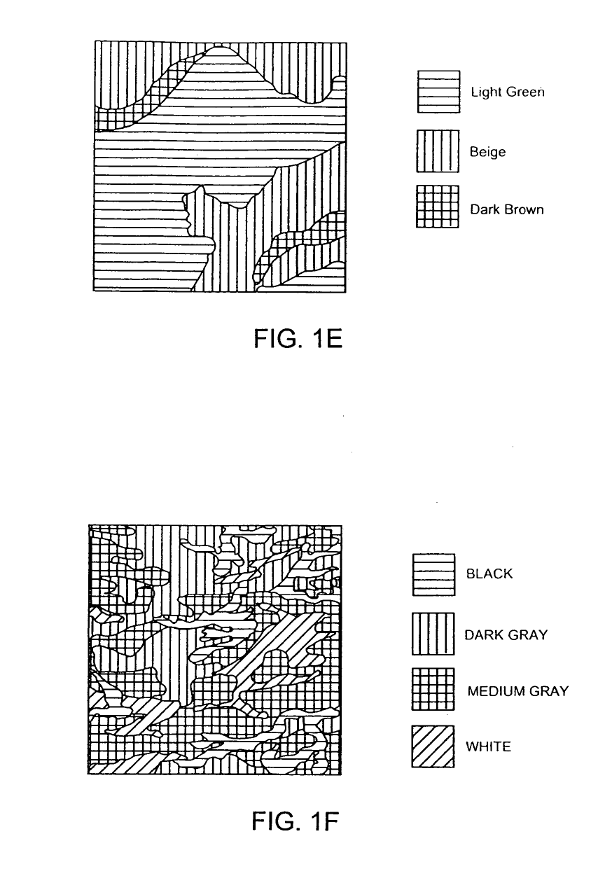

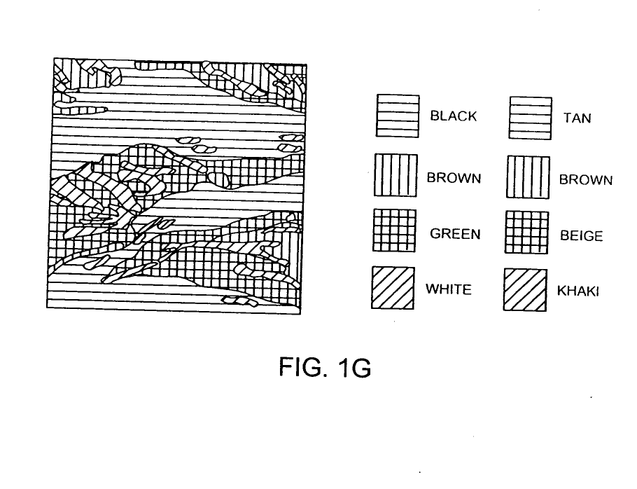

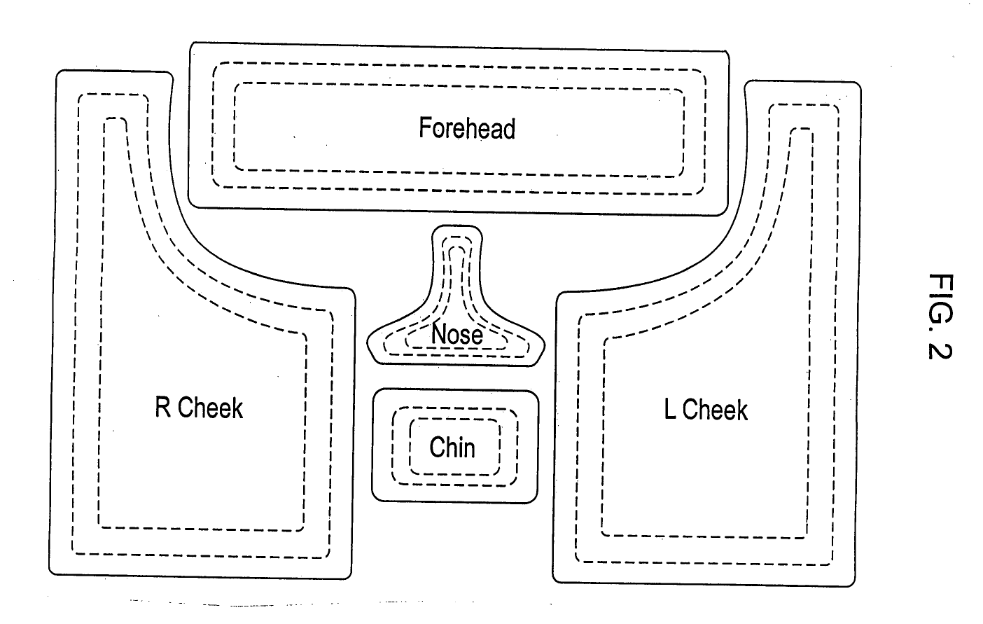

The removable tattoos of the present invention are utilized for disguising a majority of a user's face. These patterns may be designed for military applications or for recreational activities. Military patterns may include for example a variety of images that mimic the terrain of a particular area that a soldier may encounter during operations. These include for example natural images showing realistic leaves, trees, branches, rocks, etc. or may be intermixed regions of colors typically encountered in particular types of terrain such for example blacks and greens for forested terrain and brown and tans for desert terrain or they may be digitally created patterns of intermixed regions of colors that have been computer generated. FIG. 1 shows a number of examples of terrain tattoo patterns. Patterns such as these may be provided in large sheets that may be cut into appropriate sizes and shapes based on the size and shape of the face on which they are to be applied. Correspondingly the tattoos may be provided in sections such as the forehead, cheeks, chin, forehead and cheeks and/or cheeks and chin so that they maybe more easily applied.

In addition, the tattoos of the present invention may be used on other exposed areas of the body such as for example the hands. If desired the tattoo sheets may be precut into the shape of a hand for easy application. Alternatively, the user may cut the tattoo sheet into the appropriate size for application to the hand.

What is claimed is:

1. A moisture activated removable facial camouflage tattoo carrier sheet for disguising a majority of a human face comprising:
a water permeable transfer sheet,
at least one temporary and removable moisture activated facial camouflage tattoo disposed on said water permeable transfer sheet: and
a protective release sheet removably disposed on said water permeable transfer sheet over said facial camouflage tattoo for a temporary covering and protecting said facial camouflage tattoo.

2. A moisture activated removable facial camouflage tattoo carrier sheet according to claim 1 wherein the at least one temporary and removable moisture activated facial camouflage tattoo comprises water-soluble hypoallergenic vegetable dye.

3. A moisture activated removable facial camouflage tattoo carrier sheet according to claim 1 wherein said facial camouflage tattoo is transferable to and temporarily adheres to the skin of a human face upon application of water to said water permeable transfer sheet.

4. A moisture activated removable facial camouflage tattoo carrier sheet according to claim 1 wherein said image is selected from the group consisting of a woodland pattern, a desert pattern, a tiger strip pattern, and an urban pattern.

5. A moisture activated removable facial camouflage tattoo carrier sheet according to claim 4 wherein said woodland pattern is a military digital woodland pattern.

6. A moisture activated removable facial camouflage tattoo carrier sheet according to claim 4 wherein said desert pattern is selected from the group consisting of a military digital desert pattern, a chocolate-chip desert pattern and a tri-color desert pattern.

7. A moisture activated removable facial camouflage tattoo carrier sheet according to claim 1 provided in shapes to fit areas of said human face selected from the group consisting of, forehead, cheeks, chin, forehead and cheeks, cheeks and chin and forehead, cheeks and chin.

8. A moisture activated removable hand camouflage tattoo carrier sheet for disguising a majority of a human hand comprising:
a water permeable transfer sheet,
at least one temporary and removable moisture activated facial camouflage tattoo disposed on said water permeable transfer sheet: and
a protective release sheet removably disposed on said water permeable transfer sheet over said facial camouflage tattoo for a temporary covering and protecting said facial camouflage tattoo.

9. A moisture activated removable hand camouflage tattoo carrier sheet according to claim 9 wherein the at least one temporary and removable moisture activated facial camouflage tattoo comprises water-soluble hypoallergenic vegetable dye.

10. A moisture activated removable hand camouflage tattoo carrier sheet according to claim 9 wherein said facial camouflage tattoo is transferable to and temporarily adheres to the skin of a hand upon application of water to said water permeable transfer sheet.

11. A moisture activated removable hand camouflage tattoo carrier sheet according to claim 9 wherein said camouflage image is selected from the group consisting of a woodland pattern, a desert pattern, a tiger strip pattern, and an urban pattern.

12. A moisture activated removable hand camouflage tattoo carrier sheet according to claim 12 wherein said woodland pattern is a military digital woodland pattern.

13. A moisture activated removable hand camouflage tattoo carrier sheet according to claim 12 wherein said desert pattern is selected from the group consisting of a military digital desert pattern, a chocolate-chip desert pattern and a tri-color desert pattern.
